(19) United States
(12) Patent Application Publication
(10) Pub. No.: US 2023/0103001 A1
(43) Pub. Date: Mar. 30, 2023

(54) MACHINE LEARNING DEVICE, CONTROL DEVICE, AND MACHINE LEARNING METHOD

(71) Applicant: FANUC CORPORATION, Minamitsuru-gun, Yamanashi (JP)

(72) Inventors: Ryoutarou TSUNEKI, Yamanashi (JP); Satoshi IKAI, Yamanashi (JP)

(21) Appl. No.: 17/802,721

(22) PCT Filed: Apr. 8, 2021
(86) PCT No.: PCT/JP2021/014870

§ 371 Date: Aug. 26, 2022

(30) Foreign Application Priority Data
Apr. 14, 2020 (JP) 2020-072174

(51) Int. Cl. G05B 13/02; G05B 13/04

(52) U.S. Cl. CPC G05B 13/0265; G05B 13/042

(57) ABSTRACT

A machine learning device which performs machine learning to optimize at least one of a coefficient of a filter and a feedback gain, the machine learning device comprising: a state information acquiring unit which acquires state information including the at least one of the coefficient and the feedback gain and including input/output gain and input/output phase delay of a servo control device; an action information output unit which outputs action information including adjustment information for the at least one of the coefficient and the feedback gain; a reward output unit which obtains and outputs a reward on the basis of whether a Nyquist plot calculated from the input/output gain and the input/output phase delay passes through the inside of a closed curve; and a value function updating unit which updates a value function on the basis of the value of the reward, the state information, and the action information.

### TECHNICAL FIELD

The present invention relates to a machine learning device which performs machine learning to optimize at least one selected from a coefficient of at least one filter provided in a servo controller for controlling a motor and a feedback gain, a controller including the machine learning device, and a machine learning method.

### BACKGROUND ART

For example, Patent Document 1 discloses a machine learning device for performing machine learning on a coefficient of a filter and a gain of a velocity control based on a position error, etc. Specifically, Patent Document 1 discloses a machine learning device for performing machine learning on a servo motor controller including a changing unit for changing a parameter of a control unit for controlling a servo motor and a compensation value for at least one of a position command and a torque command, the machine learning device including state information acquiring means for acquiring state information including a position command, a servo state containing a position error, and a combination of a parameter and a compensation value, action information output means for outputting action information including adjustment information of the combination of the parameter and the compensation value contained in the state information, reward output means for outputting the value of a reward in reinforcement learning based on the position error included in the state information, and value function updating means for updating a value function based on the value of the reward output from the reward output means, the state information, and the action information. Further, Patent Document 1 discloses that the control unit of the servo motor controller includes a position control unit for generating a speed command based on a position command, a velocity control unit for generating a torque command based on the speed command output from the position control unit, and a filter for attenuating signals of frequencies in a predetermined frequency range of the torque command output from the velocity control unit, and the changing unit changes the gain of at least one of the position control unit and the velocity control unit, a filter coefficient of the filter, and at least one of a torque offset value and a friction compensation value to be added to the position command or the torque command based on the action information.

Further, for example, Patent Document 2 discloses a machine learning device for learning a condition to be associated with a filter unit based on at least one of a noise component of output signals of the filter unit, a noise amount, and responsiveness to input signals. Specifically, Patent Document 2 discloses a machine learning device for learning a condition to be associated with a filter unit for filtering analog input signals, the machine learning device including a state observing unit for observing a state variable number configured by at least one of a noise component of output signals of the filter unit, a noise amount and responsiveness to input signals, and a learning unit for learning a condition to be associated with the filter unit according to a training data set configured by the state variable number.

Patent Document 1: Japanese Unexamined Patent Application, Publication No. 2019-128830

Patent Document 2: Japanese Unexamined Patent Application, Publication No. 2017-34852

### DISCLOSURE OF THE INVENTION

### Problems to be Solved by the Invention

When the velocity gain or the filter is adjusted, evaluation is performed with reference to a phase margin and a gain margin as a guideline for a stability margin. However, if the phase margin and the gain margin are evaluated separately from each other, each evaluation would be made as a “point” evaluation. Therefore, even if these indicators are introduced into an evaluation function of machine learning, it is easily affected by fluctuation in measurement or the like. Therefore, it is desired to adjust at least one selected from the velocity gain and the filter in consideration of both the phase margin and the gain margin.

### Means for Solving the Problems

(1) One aspect of the present disclosure is directed to a machine learning device which performs machine learning to optimize at least one selected from a coefficient of at least one filter and a feedback gain which are provided in a servo controller for controlling a motor. The machine learning device includes:

a state information acquisition unit that acquires state information including at least one selected from the coefficient of the filter and the feedback gain and including an output/input gain and an output/input phase delay of the servo controller;

an action information output unit that outputs action information including adjustment information of at least one selected from the coefficient and the feedback gain included in the state information;

a reward output unit that determines a reward depending on whether a Nyquist path calculated from the output/input gain and the output/input phase delay passes through an inside of a closed curve which contains therein (−1, 0) on a complex plane and passes through a predetermined gain margin and phase margin, and outputs the reward; and

a value function updating unit that updates a value function based on a value of the reward output by the reward output unit, the state information, and the action information.

(2) Another aspect of the present disclosure is directed to a controller including:

the machine learning device according to (1) above;

a servo controller that controls a motor and includes at least one filter, and a control unit configured to set a feedback gain; and

a frequency response calculation device that calculates an output/input gain and an output/input phase delay of the servo controller, in the servo controller.

(3) Yet another aspect of the present disclosure is directed to a machine learning method for a machine learning device which performs machine learning to optimize at least one selected from a coefficient of at least one filter and a feedback gain which are provided in a servo controller for controlling a motor. The method includes:

acquiring state information that includes at least one selected from the coefficient of the filter and the feedback gain, and includes an output/input gain and an output/input phase delay of the servo controller;

outputting action information that includes adjustment information of at least one selected from the coefficient and the feedback gain included in the state information;

determining a reward depending on whether a Nyquist path calculated from the output/input gain and the output/input phase delay passes through an inside of a closed curve which contains therein (−1, 0) on a complex plane and passes through a predetermined gain margin and phase margin, and outputting the reward; and

updating a value function, based on a value of the reward, the state information, and the action information.

### Effects of the Invention

According to each aspect of the present disclosure, it is possible to adjust at least one selected from a feedback gain and a coefficient of a filter in consideration of both a phase margin and a gain margin, and it is possible to improve the responsiveness while ensuring the stability of a servo system without being affected by fluctuation in measurement.

### BRIEF DESCRIPTION OF THE DRAWINGS

FIG. 1 is a block diagram showing a controller including a machine learning device according to an embodiment of the present disclosure;

FIG. 2 is a block diagram showing a machine learning unit according to the embodiment of the present disclosure;

FIG. 3 is a diagram showing a Nyquist path, a unit circle, and a circle passing through a gain margin and a phase margin on a complex plane;

FIG. 4 is an explanation diagram showing a gain margin and a phase margin, and a circle passing through the gain margin and the phase margin;

FIG. 5 is a bode diagram of a closed loop;

FIG. 6 is a block diagram showing a closed-loop normative model;

FIG. 7 is a characteristic diagram showing frequency response of an output/input gain of a servo control unit of the normative model and a servo control unit before and after learning;

FIG. 8 is a flowchart showing an operation of a machine learning unit during Q-learning in the present embodiment;

FIG. 9 is a flowchart showing an operation of an optimization action information output unit of the machine learning unit of one embodiment of the present invention;

FIG. 10 is a block diagram showing an example in which a plurality of filters are directly connected to one another to configure a filter; and

FIG. 11 is a block diagram showing an example of another configuration of a controller.

### PREFERRED MODE FOR CARRYING OUT THE INVENTION

Embodiments of the present disclosure will be described in detail with reference to the drawings.

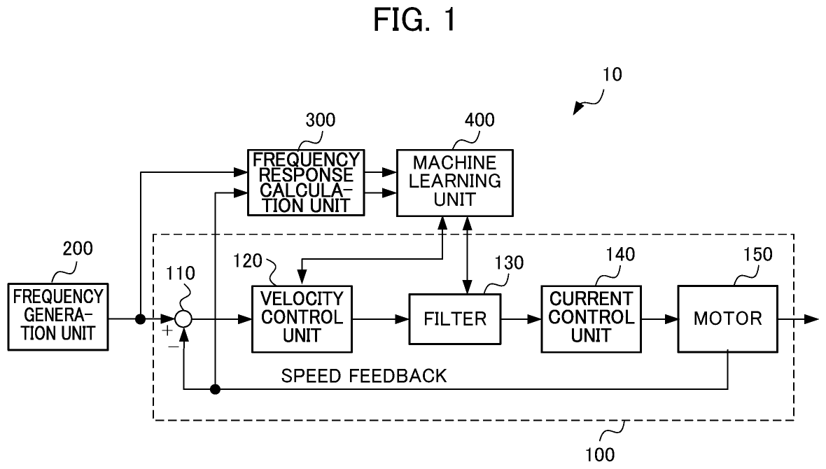

FIG. 1 is a block diagram showing a controller including a machine learning device according to an embodiment of the present disclosure. The controller 10 includes a servo control unit 100, a frequency generation unit 200, a frequency response calculation unit 300, and a machine learning unit 400. The servo control unit 100 corresponds to a servo controller, the frequency response calculation unit 300 corresponds to a frequency response calculation device, and the machine learning unit 400 corresponds to a machine learning device. One or more of the frequency generation unit 200, the frequency response calculation unit 300, and the machine learning unit 400 may be provided in the servo control unit 100. The frequency response calculation unit 300 may be provided in the machine learning unit 400.

The servo control unit 100 includes a subtractor 110, a velocity control unit 120, a filter 130, a current control unit 140, and a motor 150. The subtractor 110, the velocity control unit 120, the filter 130, the current control unit 140, and the motor 150 configure a servo system of a speed feedback loop serving as a closed loop. As the motor 150 may be used a linear motor performing a linear motion, a motor having a rotary axis, or the like. A target to be driven by the motor 150 is, for example, a machine tool, a robot, or a mechanical unit of an industrial machine. The motor 150 may be provided as a part of a machine tool, a robot, an industrial machine, or the like. The controller 10 may be provided as a part of a machine tool, a robot, an industrial machine, or the like.

The subtractor 110 determines the difference between an input speed command and a detection speed which has been fed back, and outputs the difference as a speed error to the velocity control unit 120.

The velocity control unit 120 adds an integrated value of the product of the speed error and an integral gain K1v, and a value obtained by multiplying the speed error by a proportional gain K2v to the speed error, and outputs the addition value as a torque command to the filter 130. The velocity control unit 120 serves as a control unit for setting the feedback gain.

The filter 130 is a filter for attenuating a specific frequency component, and for example, a notch filter, a low-pass filter, or a band-stop filter is used. In a machine such as a machine tool having a mechanical unit to be driven by the motor 150, a resonance point exists, so that resonance may increase in the servo control unit 100. A filter such as a notch filter can reduce resonance. The output of the filter 130 is output as a torque command to the current control unit 140. Mathematic expression 1 (hereinafter designated as Expression 1) represents a transfer function F(s) of the notch filter as the filter 130. Parameters indicate coefficients ω_{c}, τ, δ. The coefficient δ in Expression 1 is an attenuation coefficient, the coefficient ωₑ is a central angle frequency, and the coefficient τ is a specific bandwidth. When the center frequency is represented by fc and the bandwidth is represented by fw, the coefficient ω_{c} is represented by ω_{c}=2πfc, and the coefficient τ is represented by τ=fw/fc.

$$F ( s ) = \frac{{s}^{2} + 2 δ τ {ω}_{c} s + {ω}_{c}^{2}}{{s}^{2} + 2 τ {ω}_{c} s + {ω}_{c}^{2}} \qquad [ Expression 1 ]$$

The current control unit 140 generates a current command for driving the motor 150 based on the torque command, and outputs the current command to the motor 150. When the motor 150 is a linear motor, the position of a movable part is detected by a linear scale (not shown) provided in the motor 150, the position detection value is differentiated to determine a speed detection value, and the determined speed detection value is input as speed feedback to the subtractor 110. When the motor 150 is a motor having a rotary axis, the rotation angle position is detected by a rotary type encoder (not shown) provided in the motor 150, and the speed detection value is input as speed feedback to the subtractor 110. The servo control unit 100 is configured as described above, but in order to perform machine learning on at least one of an optimal gain of the gain of the velocity control unit 120 and an optimal parameter of the filter 130, the controller 10 further includes a frequency generation unit 200, a frequency response calculation unit 300, and a machine learning unit 400.

The frequency generation unit 200 outputs a sinusoidal signal as a speed command to the subtractor 110 of the servo control unit 100 and the frequency response calculation unit 300 while changing a frequency.

The frequency response calculation unit 300 uses a speed command (sine wave) as an input signal generated by the frequency generation unit 200, and a detection speed (sine wave) as an output signal output from a rotary type encoder (not shown) or integration of the detection position (sine wave) as an output signal output from a linear scale to determine an amplitude ratio (output/input gain) between the input signal and the output signal and a phase delay for each frequency specified by the speed command.

The machine learning unit 400 uses the output/input gain (amplitude ratio) and the phase delay output from the frequency response calculation unit 300 to perform machine learning on either one or both of the integral gain K1v and the proportional gain K2v of the velocity control unit 120, and at least one selected from the coefficients ω_{c}, τ and δ of the transfer function of the filter 130. The learning by the machine learning unit 400 is performed before the shipment, but re-learning may be performed after the shipment. The details of the configuration and operation of the machine learning unit 400 will be further described below. The following description will be made by exemplifying a case where the mechanical unit of the machine tool is driven by the motor 150.

### <Machine Learning Unit 400>

In the following description, a case where the machine learning unit 400 performs reinforcement learning will be described. However, the learning to be performed by the machine learning unit 400 is not particularly limited to reinforcement learning, and the present invention can be applied to, for example, a case where supervised learning is performed.

Prior to the description of each function block included in the machine learning unit 400, the basic mechanism of reinforcement learning will be first described. An agent (corresponding to the machine learning unit 400 in the present embodiment) observes the state of an environment, and selects a certain action, and the environment changes based on the action. A certain reward is given according to the environmental change, and the agent learns selections (decisions) for a better action. While supervised learning presents a complete correct answer, the reward in the reinforcement learning often presents a fragmental value based on a change in a portion of the environment. Therefore, the agent learns to select an action so that the total reward in the future is maximized.

In this way, in the reinforcement learning, the agent learns actions to learn appropriate actions based on interaction that the actions give to the environment, that is, a learning method for maximizing a reward to be obtained in the future. This shows that, in the present embodiment, the agent can acquire an action that affects the future, for example, selecting an action information for suppressing the vibration at the end of the machine.

Here, any learning method can be used for reinforcement learning, but the following description will be made by exemplifying a case of using Q-learning which is a method of learning a value Q(S,A) for selecting an action A under the state S of a certain environment. An object of Q-learning is to select an action A having the highest value Q(S,A) as an optimal action among actions A that can be taken in a certain state S.

However, at the time when the agent first starts Q-learning, the agent does not know a correct value of the value Q(S,A) at all for the combination of the state S and the action A. Therefore, the agent learns the correct value Q(S,A) by selecting various actions A under a certain state S and making a better selection of actions based on rewards given for the selected actions A.

Further, since the agent desires to maximize the total reward to be obtained in the future, the agent aims to finally achieve Q(S, A)=E[Σ(γ^{t})rₜ]. Here, E[ ] indicates an expected value, t indicates time, γ is a parameter called a discount factor to be described later, rₜ is a reward at time t, and Σ is the sum at time t. In this expression, the expected value is an expected value when the state was changed according to an optimal action. However, since it is unclear what the optimal action is in the process of Q-learning, the agent performs various actions to perform reinforcement learning while searching. Such an updating expression for the value Q(S,A) can be represented by, for example, the following expression 2 (represented as Expression 2 below).

$$Q ( {S}_{t + 1} , {A}_{t + 1} ) ← Q ( {S}_{t} , {A}_{t} ) + α ( {r}_{t + 1} + {γmax}_{A} Q ( {S}_{t + 1} , A ) - Q ( {S}_{t} , {A}_{t} ) ) \qquad [ Expression 2 ]$$

In the above Expression 2, Sₜ represents the state of the environment at a time t, and Aₜ represents an action at the time t. By the action Aₜ, the state changes to Sₜ₊₁.

rₜ₊₁ indicates a reward obtained by the change in the state. Moreover, a term with max is a multiplication of the value Q by γ when an action A having the highest value Q known at that moment is selected under the state Sₜ₊₁. Here, γ is a parameter of 0<γ≤1 and is called a discount rate. Moreover, α is a learning coefficient and is in the range of 0<α≤1.

The above-mentioned Expression 2 shows a method of updating a value Q(Sₜ, Aₜ) of an action Aₜ in a state Sₜ based on a reward rₜ₊₁ returned as a result of a trial Aₜ. This updating expression indicates that if the value maxₐ Q(Sₜ₊₁,A) of the best action in the next state Sₜ₊₁ associated with the action Aₜ is larger than the value Q(Sₜ,Aₜ) of the action Aₜ in the state Sₜ, Q(Sₜ,A_{L}) is increased, and if it is smaller, Q(Sₜ,Aₜ) is decreased. In other words, the updating expression approaches the value of an action in a state to the value of the best action in the next state associated with the action. However, although the difference differs depending on the discount rate γ and the reward rₜ₊₁, the value of the best action in a certain state basically propagates to the value of an action in a state previous to that state.

Here, a Q-learning method of creating a Q(S,A) table for all state-action pairs (S,A) to perform learning is known. However, when this learning method is used, the number of states is too large to obtain the values of Q(S, A) for all state-action pairs, and it may take a lot of time for Q-learning to converge.

Therefore, a known technique called DQN (Deep Q-Network) may be used. Specifically, a value function Q is configured with an appropriate neural network by utilizing DQN, and parameters of the neural network are adjusted, whereby the value function Q may be approximated by an appropriate neural network to calculate the value Q(S, A). By using DQN, it is possible to shorten the time required for convergence of Q-learning. The details of DQN are disclosed in the Non-Patent Document below, for example.

### Non-Patent Document

“Human-level control through deep reinforcement learning”, by Volodymyr Mnihl [online], [searched on Jan. 17, 2017], Internet <URL: http://files.davidqiu.com/research/nature 14236.pdf>

The machine learning unit 400 performs the Q-learning described above. Specifically, the machine learning unit 400 learns a value Q for setting, as a state S, an integral gain K1v and a proportional gain K2v of the velocity control unit 120, the values of respective coefficients ω_{c}, τ, δ of the transfer function of the filter 130, and an output/input gain (amplitude ratio) and a phase delay output from the frequency response calculation unit 300, and for selecting, as an action A related to the state S, adjustment of the integral gain K1v and the proportional gain K2v of the velocity control unit 120 and the values of the respective coefficients ω_{c}, τ, δ of the transfer function of the filter 130.

Based on the integral gain K1v and the proportional gain K2v of the velocity control unit 120 and the respective coefficients ω_{c}, τ, δ of the transfer function of the filter 130, the machine learning unit 400 observes state information S containing the output/input gain and the phase delay for each frequency obtained by driving the servo control unit 100 by using a speed command, which is a frequency-changing sinusoidal wave described above, and thereby determines the action A. The machine learning unit 400 returns a reward every time the action A is performed. The machine learning unit 400, for example, searches for an optimal action A by trial and error so that the total of rewards in the future is maximized. This enables the machine learning unit 400 to select the optimal action A (that is, the integral gain K1v and the proportional gain K2v of the velocity control unit 120, and the optimal coefficients ω_{c}, τ, δ of the transfer function of the filter 130) for the state S containing the output/input gain and the phase delay for each frequency obtained from the frequency response calculation unit 300 by driving the servo control unit 100 using the speed command as the frequency-changing sinusoidal wave based on the integral gain K1v and the proportional gain K2v of the velocity control unit 120 and the respective coefficients we, T, 6 of the transfer function of the filter 130.

That is, based on a learned value function Q, the machine learning unit 400 selects such an action A as maximizing the value of Q from actions A to be applied with respect to an integral gain K1v and a proportional gain K2v of the velocity control unit 120 and respective coefficients ω_{c}, τ, δ of the transfer function of the filter 130, which is related to a certain state S. By selecting such an action A as maximizing the value of Q, the machine learning unit 400 can select such an action A (that is, an integral gain K1v and a proportional gain K2v of the velocity control unit 120 and/or respective coefficients ω_{c}, τ, δ of the transfer function of the filter 130) that a stability margin of the servo control unit 100 generated by executing a program for generating a frequency-changing sinusoidal signal is equal to or greater than a predetermined value.

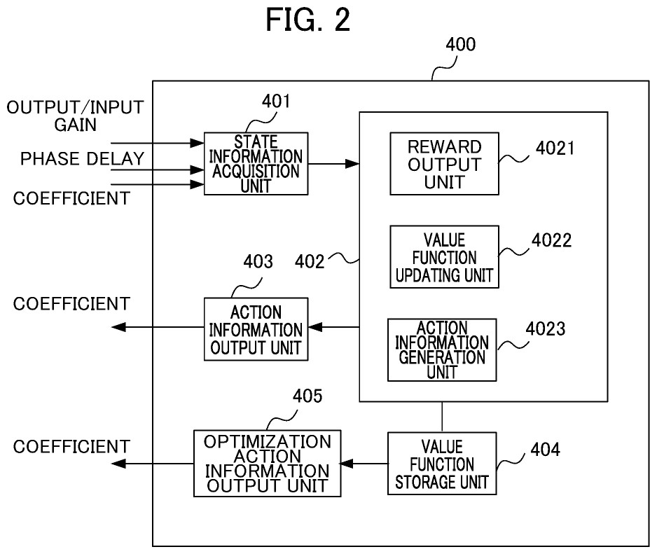

FIG. 2 is a block diagram showing a machine learning unit 400 according to an embodiment of the present disclosure. In order to perform the reinforcement learning described above, as shown in FIG. 2, the machine learning unit 400 includes a state information acquisition unit 401, a learning unit 402, an action information output unit 403, a value function storage unit 404, and an optimization action information output unit 405. The learning unit 402 includes a reward output unit 4021, a value function updating unit 4022, and an action information generation unit 4023.

The state information acquisition unit 401 acquires, from the frequency response calculation unit 300, the state S containing the output/input gain (amplitude ratio) and the phase delay obtained by driving the servo control unit 100 using the speed command based on the integral gain K1v and the proportional gain K2v of the velocity control unit 120 and the respective coefficients ω_{c}, τ, δ of the transfer function of the filter 130. The state information S corresponds to the environmental state S in the Q-learning. The state information acquisition unit 401 outputs the acquired state information S to the learning unit 402.

The integral gain K1v and the proportional gain K2v of the velocity control unit 120 and the respective coefficients ω_{c}, τ, δ of the transfer function of the filter 130 at the time point when the Q-learning is first started is generated by a user in advance. In the present embodiment, the machine learning unit 400 adjusts and optimizes, by reinforcement learning, initial set values of the integral gain K1v and the proportional gain K2v of the velocity control unit 120 and/or the respective coefficients ω_{c}, τ, δ of the transfer function of the filter 130, which are created by the user. With respect to the integral gain K1v, the proportional gain K2v, and the coefficients ω_{c}, τ, δ, when an operator adjusts the machine tool in advance, machine learning may be performed by using adjusted values as initial values.

The learning unit 402 is a part for learning a value Q(S,A) when selecting a certain action A under a certain environmental state S.

First, the reward output unit 4021 of the learning unit 402 will be described. The reward output unit 4021 is a part for acquiring a reward when an action A is selected under a certain state S.

The speed feedback loop is configured by a subtractor 110, and an open-loop circuit of a transfer function H. The open-loop circuit is configured by the velocity control unit 120, the filter 130, the current control unit 140, and the motor 150 shown in FIG. 1. When the output/input gain of the speed feedback loop is represented by c and the phase delay is represented θ at a certain frequency ω₀, the closed-loop frequency response G(jω₀) is represented by c·e^{jθ}. By using the open-loop frequency response H(jω₀), the closed-loop frequency response G(jω₀) is represented by G(jω₀)=H(jω₀)/(1+H(jω₀)). Therefore, the open-loop frequency response H(jω₀) at a certain frequency ω₀ can be determined by H(jω₀)=G(jω₀)/(1−G(jω₀))=c·e^{jθ}/(1−ce_{jθ}).

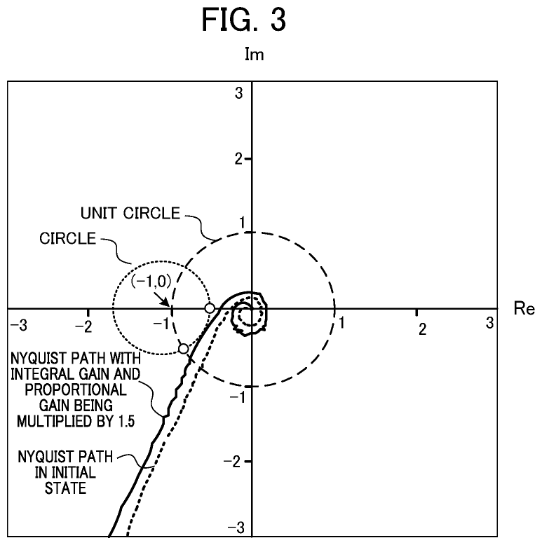

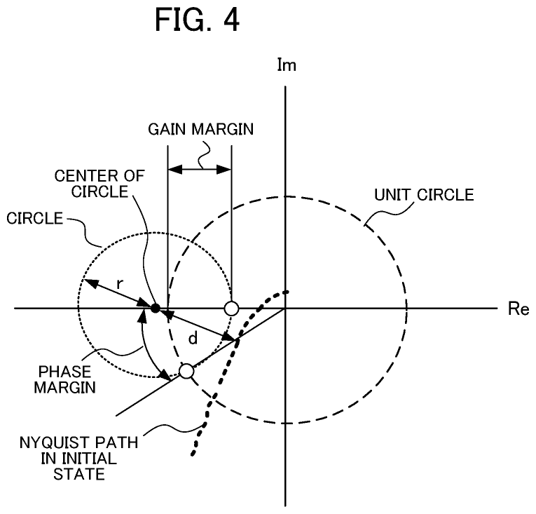

The reward output unit 4021 acquires, from the state information acquisition unit 401, the output/input gain and the phase delay acquired by driving the servo control unit 100 using the frequency-changing speed command (sinusoidal wave) based on the integral gain K1v and the proportional gain K2v and the coefficients ω_{c}, τ, δ. When the changing frequency is represented by ω, the open-loop frequency response H(jω) can be determined by the relational expression H(jω)=G(jω)/(1−G(jω)), as described above. The reward output unit 4021 uses the output/input gain and the phase delay obtained from the state information acquisition unit 401 to draw the open-loop frequency response H(jω) on the complex plane, thereby creating a Nyquist path. The Nyquist path in the initial state is obtained by driving the servo control unit 100 using the speed command (sinusoidal wave) based on the integral gain K1v and the coefficients ω_{c}, τ, δ, which are set by the user. The Nyquist path in the process of Q-learning is obtained by modifying the integral gain K1v, the proportional gain K2v, and/or the coefficients ω_{c}, τ, δ, and driving the servo control unit 100 using the speed command (sinusoidal wave). FIG. 3 is a diagram showing a Nyquist path, a unit circle, and a circle passing through a gain margin and a phase margin on a complex plane. FIG. 3 shows a Nyquist path in an initial state (dotted line) and a Nyquist path (solid line) obtained by multiplying each of the proportional gain and the integral gain by 1.5. FIG. 4 is an explanation diagram showing the gain margin, the phase margin, and the circle passing through the gain margin and the phase margin.

The user sets the values of the gain margin and the phase margin of the open-loop circuit 100A in advance. As shown in FIG. 3 and FIG. 4, when a unit circle passing through (−1,0) is drawn on the complex plane, it is possible to indicate the gain margin set by the user on the real axis and indicate the phase margin set by the user on the unit circle.

The reward output unit 4021 creates, on the complex plane, a closed curve that includes (−1, 0) therein and passes through the gain margin on the real axis and the phase margin on the unit circle. The following description will be made assuming that the closed curve is a circle, the radius of the circle is a radius r, and the shortest distance between the circle and the Nyquist path is a shortest distance d as shown in FIG. 3 and FIG. 4. In this case, the shortest distance d is defined as the shortest distance between the center of the circle (black dot in FIG. 4) and the Nyquist path. However, the shortest distance d is not limited to this definition, and for example, it may be the shortest distance between the outer circumference of the circle and the Nyquist path. The closed curve is not limited to a circle, and may be a closed curve other than the circle, such as a rhombus, a quadrangle, or an ellipse.

The reward output unit 4021 gives a negative reward when the shortest distance d is smaller than the radius r (d<r) and the Nyquist path passes through the inside of the closed curve. On the other hand, when the shortest distance d is equal to or larger than the radius r (d≥r) and the Nyquist path does not pass through the inside of the circle, the reward output unit 4021 gives a reward of zero or a positive value.

By giving a reward as described above, the machine learning unit 400 searches for the integral gain K1v and the proportional gain K2v of the velocity control unit 120 and the coefficients ω_{c}, τ, δ of the transfer function of the filter 130 by trial and error so that the Nyquist path does not pass through the inside of the circle and the gain margin and the phase margin are equal to or greater than the values set by the user.

In the example described above, whether or not the Nyquist path passes through the inside of a circle which is a closed curve is determined based on the shortest distance between the circle and the Nyquist path, but the present invention is not limited to this method, and other methods may be used. For example, the determination may be made based on whether or not the Nyquist path touches or intersects the outer circumference of a circle which is a closed curve.

### (Example Considering Response Speed)

When the Nyquist path passes over the circle (d=r) or outside the circle (d>r), the gain margin and the phase margin increase as the Nyquist path is farther away from the circle, and the stability degree of the servo system increases. However, the feedback gain decreases and the response speed decreases. Therefore, it is desirable that the reward output unit 4021 gives a reward so that the feedback gain is as large as possible with a gain margin and a phase margin which are equal to or greater than those determined by the user. Three examples of a method for determining a reward so that the feedback gain is as large as possible with a gain margin and a phase margin which are equal to or greater than those determined by the user will be described hereunder.

### (1) Method for Determining Reward Based on Cutoff Frequency

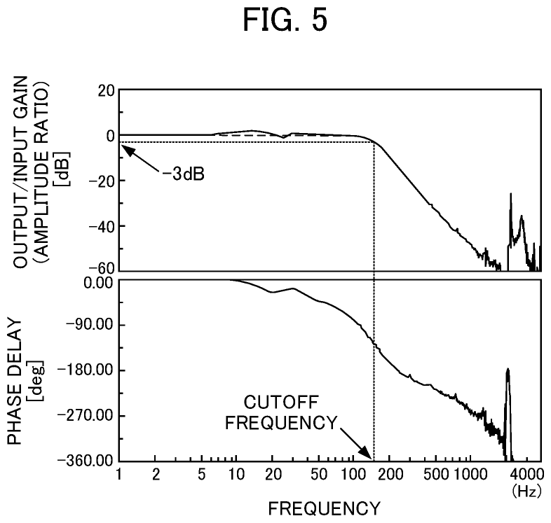

The reward output unit 4021 creates a bode diagram from the output/input gain (amplitude ratio) and the phase delay of the closed loop obtained by driving the servo control unit 100 using the speed command (sinusoidal wave) based on the integral gain K1v, the proportional gain K2v, and the coefficients ω_{c}, τ, δ. FIG. 5 shows an example of a bode diagram of a closed-loop. The cutoff frequency is, for example, a frequency at which the gain characteristic of the bode diagram is equal to −3 dB, or a frequency at which the phase characteristic is equal to −180 degrees. In FIG. 5, the frequency at which the gain characteristic is equal to −3 dB is shown as the cutoff frequency.

The reward output unit 4021 determines a reward so that the cutoff frequency [frequency] increases. Specifically, the reward output unit 4021 modifies the integral gain K1v, the proportional gain K2v, and/or the coefficients ω_{c}, τ, δ, and coefficient ω_{c}, τ, δ, and determines the reward depending on whether the cutoff frequency fcut increases, does not change, or decreases when the state S before the modification is changed to a state S′. In the following description, the cutoff frequency fcut in the state S is referred to as fcut(S), and the cutoff frequency fcut in the state S′ is referred to as fcut(S′).

When the cutoff frequency fcut increases upon change of the state S to the state S′, the reward output unit 4021 gives a reward of a positive value because of the cutoff frequency fcut (S′)>the cutoff frequency fcut (S). When the cutoff frequency fcut does not change upon change of the state S to the state S′, the reward output unit 4021 gives a reward of a value of zero because of the cutoff frequency fcut(S′)=the cutoff frequency fcut (S). When the cutoff frequency fcut decreases upon change of the state S to the state S′, the reward output unit 4021 gives a reward of a negative value because of the cutoff frequency fcut(S′)<the cutoff frequency fcut(S).

By determining the reward as described above, the machine learning unit 400 searches for the integral gain K1v and the proportional gain K2v of the velocity control unit 120 and the coefficients we, T, S of the transfer function of the filter 130 by trial and error so that the cutoff frequency fcut increases when the Nyquist path passes over or outside a circle. The increase of the cutoff frequency fcut causes the feedback gain to be larger, and causes the response speed to be higher.

### (2) Method for Determining Rewards Based on Closed-Loop Characteristic

The reward output unit 4021 acquires a transfer function G(jω) of the closed loop from the output/input gain (amplitude ratio) and the phase delay of the closed loop acquired by driving the servo control unit 100 using the speed command (sinusoidal wave) based on the integral gain K1v and the proportional gain K2v, and the coefficients ω_{c}, τ, δ. The reward output unit 4021 can apply f=Σ|1−G(jω)|² as an evaluation function f in a preset frequency region. The reward output unit 4021 determines the reward so that the value of the evaluation function f decreases. Specifically, the reward output unit 4021 modifies the integral gain K1v and the proportional gain K2v, and/or the coefficients ω_{c}, τ, δ, and determines the reward depending on whether the value of the evaluation function f deceases, does not change, or increases when the state S before the modification changes to the state S′. In the following description, the value of the evaluation function f in the state S is referred to as f(S), and the value of the evaluation function f in the state S′ is referred to as f(S′). The smaller the value of the evaluation function f, the larger the cut-off frequency of the bode diagram of the closed loop shown in FIG. 5.

When the value of the evaluation function f decreases upon change of the state S to the state S′, the reward output unit 4021 gives a reward of a positive value because of the value of the evaluation function f(S′)<the value of the evaluation function f(S). When the value of the evaluation function f does not change upon change of the state S to the state S′, the reward output unit 4021 gives a reward of a value of zero because of the value of the evaluation function f(S′)=the value of the evaluation function f(S). When the value of the evaluation function f increases upon change of the state S to the state S′, the reward output unit 4021 gives a reward of a negative value because of the value of the evaluation function f(S′)>the value of the evaluation function f(S).

By determining the reward as described above, the machine learning unit 400 searches for the integral gain K1v and the proportional gain K2v of the velocity control unit 120 and the coefficients ω_{c}, τ, δ of the transfer function of the filter 130 by trial and error so that the value of the evaluation function f decrease when the Nyquist path passes over or outside a circle. The decrease of the value of the evaluation function f causes the feedback gain to be larger, and causes the response speed to be higher.

(3) Method for Determining Reward so that the Shortest Distance d is Closer to the Radius r.

When the Nyquist path passes over the circle (d=r) or outside the circle (d>r), the reward is determined so that the Nyquist path approaches the closed curve. Specifically, the reward output unit 4021 modifies the integral gain K1v, the proportional gain K2v, and/or the coefficients ω_{c}, τ, δ, and the reward is determined depending on whether the shortest distance d between the center of the circle and the Nyquist path decreases, does not change, or increases when the state S before the modification changes to the state S′. In the following description, the shortest distance d in the state S is referred to as d(s), and the shortest distance d in the state S′ is referred to as d(s′).

In the case where the state S changes to the state S′, the reward output unit 4021 gives a reward of a positive value because of the shortest distance d(S′)<the shortest distance d(S) when the shortest distance d decreases. In the case where the state S changes to the state S′, the reward output unit 4021 gives a reward of a value of zero because of the shortest distance d(S′)=the shortest distance d(S) when the shortest distance d does not change. In the case where the state S changes to the state S′, the reward output unit 4021 gives a reward of a negative value because of the shortest distance d(S′)>the shortest distance d(S) when the shortest distance d increases.

By determining the reward as described above, the machine learning unit 400 searches for the integral gain K1v and the proportional gain K2v of the velocity control unit 120, and/or the coefficients ω_{c}, τ, δ of the transfer function of the filter 130 so that the Nyquist path passes over the circle or approaches the outer circumference of the circle. As the Nyquist path passes over the circle or approaches the circumference of the circle, the feedback gain increases, and the response speed increases. The method for determining the reward based on the information of the shortest distance d is not limited to the above method, and other methods can be applied.

### (Example Considering Resonance)

Even when the Nyquist path passes over the circle (d=r) or outside the circle (d>r), the output/input gain may increase due to resonance at a machine end of a machine as a control target. Therefore, it is desirable that the reward output unit 4021 determines a reward so as to suppress the resonance with a gain margin and a phase margin which are equal to or greater than those determined by the user. The method for determining a reward by comparing an open-loop characteristic with a normative model will be described below.

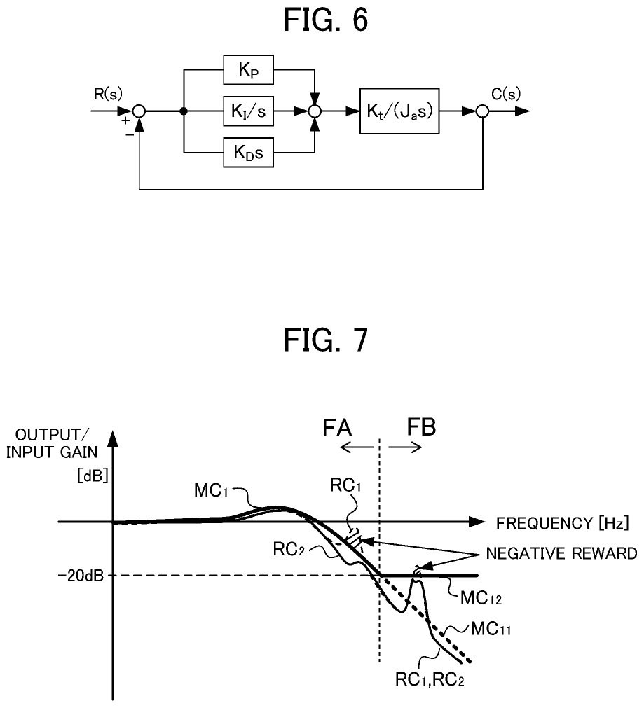

Hereinafter, an operation of giving a negative reward by the reward output unit 4021 when the output/input gain for each frequency in a created frequency response is larger than the output/input gain of a normative model will be described with reference to FIG. 6 and FIG. 7.

The reward output unit 4021 saves a normative model of the output/input gain. The normative model is a model of a servo control unit having an ideal characteristic having no resonance. The normative model can be calculated from, for example, an inertia Ja, a torque constant Kₜ, a proportional gain Kₚ, an integral gain K_{I}, and a differential gain K_{D} of a model shown in FIG. 6. The inertia Ja is the sum of a motor inertia and a machine inertia.

FIG. 7 is a characteristic diagram showing the frequency response of the output/input gain in the servo control unit of the normative model and the servo control unit 100 before and after learning. As shown in the characteristic diagram of FIG. 7, the normative model includes a zone FA which is a frequency zone having an ideal output/input gain of a constant output/input gain or more, for example, −20 dB or more, and a zone FB which is a frequency zone whose output/input gain is less than a constant output/input gain. In the zone FA of FIG. 7, the ideal output/input gain of the normative model is represented by a curve MC, (bold line). In the zone FB of FIG. 7, an ideal virtual output/input gain of the normative model is represented by a curve MC₁₁ (bold broken line), and the output/input gain of the normative model is set to a constant value and represented by a straight line MC₁₂ (bold line). In the zones FA and FB of FIG. 7, the curves of the output/input gains of the servo control unit before and after learning are represented by curves RC₁ and RC₂, respectively.

In the zone FA, the reward output unit 4021 gives a negative reward when the curve RC₁ of the output/input gain before learning for each frequency in the created frequency response exceeds the curve MC₁ of the ideal output/input gain of the normative model. In the zone FB exceeding a frequency at which the output/input gain becomes sufficiently small, even when the curve RC₁ of the output/input gain before learning exceeds the curve MC₁₁ of the ideal virtual output/input gain of the normative model, the effect on stability is little. Therefore, in the zone FB, as described above, not the curve MC₁₁ of the ideal gain characteristic, but the straight line MC₁₂ of the output/input gain of a constant value (for example, −20 dB) is used as the output/input gain of the normative model. However, when the curve RC₁ of the output/input gain measured before learning exceeds the straight line MC₁₂ of the output/input gain of a constant value, it may cause instability, so that the reward output unit 4021 gives a negative value as a reward.

When the gain of the output/input gain is adjusted, the action information output unit 403 adjusts the integral gain K1v and the proportional gain K2v of the velocity control unit 120, and/or the coefficients ω_{c}, τ, δ of the transfer function of the filter 130. With respect to the characteristics of the filter 130, the gain and the phase change depending on the bandwidth fw of the filter 130, and the gain and the phase change depending on the attenuation coefficient k of the filter 130. Therefore, the action information output unit 403 can adjust the gain of the output/input gain by adjusting the coefficients of the filter 130.

In the case where the reward output unit 4021 gives a reward of a negative value when the shortest distance d is smaller than the radius r (d<r) and the Nyquist path passes through the inside of the closed curve, the reward output unit 4021 outputs this reward of the negative value to the value function updating unit 4022. In the case where the reward output unit 4021 gives a reward of a positive value when the shortest distance d is equal to or greater than the radius r (d≥r) and the Nyquist path does not pass through the inside of the circle, the reward output unit 4021 outputs this reward of the positive value to the value function updating unit 4022. When the reward output unit 4021 gives a reward in three examples considering the response speed or an example considering resonance, the reward output unit 4021 outputs, to the value function updating unit 4022, a total reward obtained by adding the above reward to a reward of a positive value to be given when the Nyquist path does not pass through the inside of the circle.

When a reward is added, the reward may be weighted. For example, when the stability of the servo system is emphasized, the reward of a positive value to be given when the Nyquist path does not pass through the inside of the circle may be weighted so as to be higher in importance than the reward to be given in the three examples considering the response speed or the example considering resonance. The reward output unit 4021 has been described above.

The value function updating unit 4022 performs Q-learning based on the state S, the action A, the state S′ when the action A is applied to the state S, and the reward obtained as described above to update the value function Q stored in the value function storage unit 404. The value function Q may be updated by online learning, batch learning, or mini-batch learning. The online learning is a learning method for updating the value function Q immediately whenever the current state S transits to the new state S′ due to application of a certain action A to the current state S. Further, the batch learning is a learning method for repeating transition of the state S to the new state S′ caused by applying a certain action A to the current state S to collect data for learning, and updating the value function Q by using all the collected data for learning. Mini-batch learning is a learning method which is intermediate between online learning and batch learning and involves updating the value function Q whenever a certain amount of learning data is collected.

The action information generation unit 4023 selects the action A in the process of Q-learning for the current state S. In the process of Q-learning, the action information generation unit 4023 creates action information A and outputs the action information A to the action information output unit 403 in order to perform an operation of modifying the integral gain K1v and the proportional gain K2v of the velocity control unit 120, and/or the respective coefficients ω_{c}, τ, δ of the transfer function of the filter 130 (corresponding to the action A in Q-learning). More specifically, the action information generation unit 4023, for example, incrementally adds or subtracts the integral gain K1v and the proportional gain K2v of the velocity control unit 120 and the respective coefficients ω_{c}, τ, δ of the transfer function of the filter 130 contained in the action A to or from the integral gain K1v and the proportional gain K2v of the velocity control unit 120 and the respective coefficients ω_{c}, τ, δ of the transfer function of the filter 130 contained in the state S.

The action information generation unit 4023 may generate the action information A so as to modify all of the integral gain K1v and the proportional gain K2v of the velocity control unit 120 and the respective coefficients ω_{c}, τ, δ of the filter 130, but may generate the action information A so as to modify some of the coefficients. When each of the coefficients ω_{c}, τ, δ of the filter 130 is modified, for example, the center frequency fc at which resonance occurs is easily found, and the center frequency fc is easily specified. Therefore, in order to perform an operation of temporarily fixing the center frequency fc and modifying the bandwidth fw and the attenuation coefficient δ, that is, fixing the coefficient ω_{c} (=2πfc) and modifying the coefficient τ(=fw/fc) and the attenuation coefficient δ, the action information generation unit 4023 may generate the action information A and output the generated action information A to the action information output unit 403.

Further, the action information generation unit 4023 may adopt a measure for selecting an action A′ by a known method such as a greedy method for selecting an action A′ having the highest value Q(S, A) among the values of currently estimated actions A or an ε greedy method for randomly selecting an action A′ with a small probability e and selecting an action A′ having the highest value Q(S, A) in the other cases.

The action information output unit 403 is a portion for transmitting action information A output from the learning unit 402 to the velocity control unit 120 and the filter 130. As described above, by finely modifying the current state S, that is, the currently set integral gain K1v and proportional gain K2v of the velocity control unit 120 and/or the currently set respective coefficients ω_{c}, τ, δ based on this action information, the current state S transits to the next state S′ (that is, the modified integral gain K1v and proportional gain K2v of the velocity control unit 120 and/or the modified respective coefficients ω_{c}, τ, δ of the filter 130).

The value function storage unit 404 is a storage device for storing the value function Q. The value function Q may be stored as a table (hereinafter, referred to as an action value table) for each state S and each action A, for example. The value function Q stored in the value function storage unit 404 is updated by the value function updating unit 4022. Further, the value function Q stored in the value function storage unit 404 may be shared with another machine learning unit 400. If the value function Q is shared by a plurality of machine learning units 400, the respective machine learning units 400 can perform reinforcement learning in a distributive manner, so that the efficiency of reinforcement learning can be improved.

The optimization action information output unit 405 generates action information A (hereinafter referred to as “optimization action information”) for causing the velocity control unit 120 and the filter 130 to perform an operation maximizing the value Q(S, A) based on the value function Q updated by the value function updating unit 4022 performing the Q-learning. More specifically, the optimization action information output unit 405 acquires the value function Q stored in the value function storage unit 404. This value function Q is updated by the value function updating unit 4022 performing Q-learning as described above. The optimization action information output unit 405 generates action information based on the value function Q, and outputs the generated action information to the velocity control unit 120 and/or the filter 130. This optimization action information contains information for modifying the integral gain K1v and the proportional gain K2v of the velocity control unit 120 and/or the respective coefficients ω_{c}, τ, δ of the transfer function of the filter 130 as in the case of the action information to be output in the process of the Q-learning by the action information output unit 403.

In the velocity control unit 120, the integral gain K1v and the proportional gain K2v are modified based on this action information, and in the filter 130, each of the coefficients ω_{c}, τ, δ of the transfer function is modified. In the above operation, the machine learning unit 400 can be operated to optimize the integral gain K1v and the proportional gain K2v of the velocity control unit 120 and/or the respective coefficients ω_{c}, τ, δ of the transfer function of the filter 130 to make the stability margin of the servo control unit 100 equal to or greater than a predetermined value. Further, in the above operation, the machine learning unit 400 can be operated to optimize the integral gain K1v and the proportional gain K2v of the velocity control unit 120 and/or the respective coefficients ω_{c}, τ, δ of the transfer function of the filter 130 to make the stability margin of the servo control unit 100 equal to or greater than a predetermined value, and increase the feedback gain to increase the response speed and/or suppress the resonance. As described above, by using the machine learning unit 400 of the present disclosure, it is possible to simplify the adjustment of the gain of the velocity control unit 120 and the parameters of the filter 130.

The function block included in the controller 10 has been described above. In order to implement these function blocks, the controller 10 includes an operation processing device such as CPU (Central Processing Unit). The controller 10 includes an auxiliary storage device such as HDD (Hard Disk Drive) in which various control programs such as application software and OS (Operating System) are stored, and a main storage device such as RAM (Random Access Memory) for storing data which are temporarily required for the operation processing device to execute a program.

In the controller 10, the operation processing device reads out the application software and the OS from the auxiliary storage device, and performs operation processing based on these application software and OS while causing the main storage device to develop the read-out application software and OS. Various types of hardware disposed in respective devices are controlled on the basis of the arithmetic result. In this way, the functional blocks of the present embodiment are realized. That is, the present embodiment can be realized by the cooperation of hardware and software.

Since the machine learning unit 400 performs a large amount of operations associated with machine learning, for example, a personal computer is equipped with GPU (Graphics Processing Units), and GPU is used for operation processing associated with the machine learning by a technique called GPGPU (General-Purpose computing on Graphics Processing Units), thereby enabling high speed processing to be performed. Furthermore, in order to perform higher-speed processing, a computer cluster may be built using a plurality of computers equipped with such GPUs, and the plurality of computers included in the computer cluster may perform parallel processing.

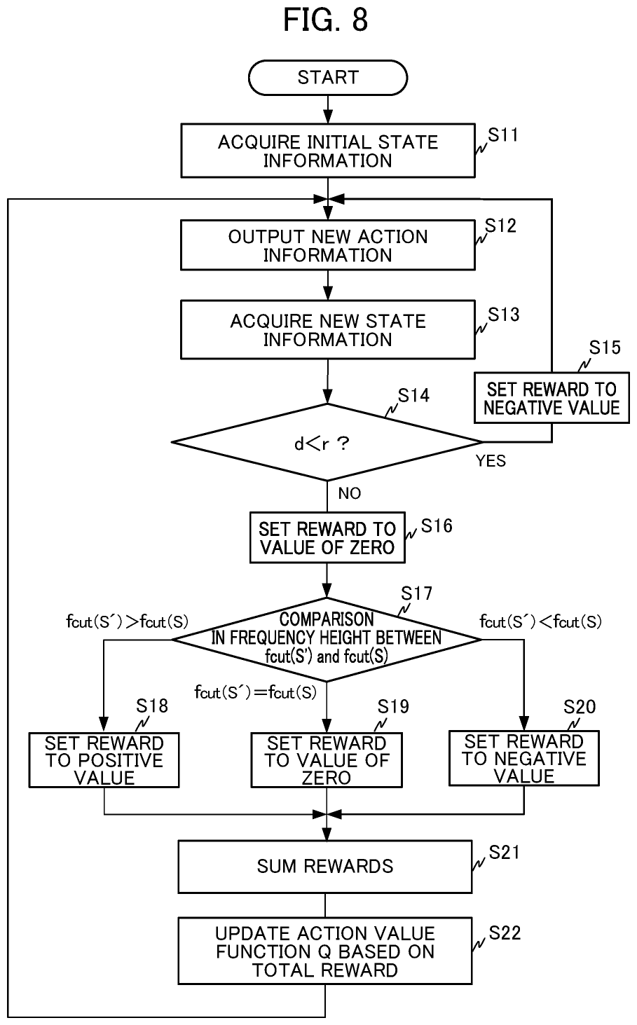

Next, the operation of the machine learning unit 400 during Q-learning in the present embodiment will be described with reference to the flowchart of FIG. 8. The flowchart described below shows a learning operation to be performed by the machine learning unit 400 so that a reward is given based on a cutoff frequency to improve the response speed after a reward is given depending on whether the Nyquist path passes through the inside of the closed curve to improve the stability of the servo system.

In Step S11, the state information acquisition unit 401 acquires first state information S from the servo control unit 100 and the frequency generation unit 200. The acquired state information is output to the value function updating unit 4022 and the action information generation unit 4023. As described above, the state information S corresponds to the state in the Q-learning.

The output/input gain (amplitude ratio) Gs(S₀) and the phase delay Θs(S₀) in the state S₀ at the time when Q-learning is first started are acquired from the frequency response calculation unit 300 by driving the servo control unit 100 using the speed command which is a frequency-changing sinusoidal wave. The speed command and the detection speed are input to the frequency response calculation unit 300, and the output/input gain (amplitude ratio) Gs(S₀) and the phase delay Θs(S₀) that are output from the frequency response calculation unit 300 are sequentially input as first state information to the state information acquisition unit 401. The initial values of the integral gain K1v and the proportional gain K2v of the velocity control unit 120 and the respective coefficients ω_{c}, τ, δ of the transfer function of the filter 130 are created in advance by the user, and the initial values of the integral gain K1v, the proportional gain K2v, and the coefficients ω_{c}, τ, δ are transmitted as first state information to the state information acquisition unit 401.

In Step S12, the action information generation unit 4023 generates new action information A, and outputs the generated new action information A to the velocity control unit 120 and/or the filter 130 via the action information output unit 403. The action information generation unit 4023 outputs new action information A based on the above-mentioned measure. The servo control unit 100 that has received the action information A drives the motor 150 with the speed command, which is a frequency-changing sinusoidal wave, based on the state S′ in which the integral gain K1v and the proportional gain K2v of the velocity control unit 120 and/or the respective coefficients ω_{c}, τ, δ of the transfer function of the filter 130 which are associated with the current state S are modified based on the received action information. As described above, the action information corresponds to the action A in the Q-learning.

In Step S13, the state information acquisition unit 401 acquires, as new state information, the output/input gain (amplitude ratio) Gs(S′) and the phase delay Θs(S′), the integral gain K1v and the proportional gain K2v of the velocity control unit 120, and the respective coefficients ω_{c}, τ, δ of the transfer function from the filter 130 in the new state S′. The acquired new state information is output to the reward output unit 4021.

In Step S14, the reward output unit 4021 determines the open-loop frequency response H(jω) based on the data of the output/input gain (amplitude ratio) and the phase delay output from the frequency response calculation unit 300. The reward output unit 4021 creates a Nyquist path by drawing the open-loop frequency response H(jω) on the complex plane. The reward output unit 4021 creates, on the complex plane, a closed curve which includes (−1,0) therein and passes through the gain margin on the real axis and the phase margin on the unit circle, and determines whether the shortest distance d is smaller than the radius r (d<r) or not (d≥r).

When the reward output unit 4021 determines in Step S14 that the shortest distance d is smaller than the radius r (d<r), in Step S15, the reward output unit 4021 sets the reward to a negative value, and returns to Step S12. When the reward output unit 4021 determines in Step S14 that the shortest distance d is equal to or larger than the radius (d≥r), in Step S16, the reward output unit 4021 sets the reward to the value of zero, and shifts to Step S17.

In Step S17, the reward output unit 4021 determines the change in frequency of the cutoff frequency fcut, that is, whether the cutoff frequency fcut becomes higher, the same, or becomes lower. The cutoff frequency fcut in the state S is referred to as fcut(S), and the cutoff frequency fcut in the state S′ is referred to as fcut(S′).

When the reward output unit 4021 determines cutoff frequency fcut(S′)>cutoff frequency fcut(S) in Step S17, the reward output unit 4021 gives a reward of a positive value in Step S18. When the reward output unit 4021 determines cutoff frequency fcut(S′)=cutoff frequency fcut(S) in Step S17, the reward output unit 4021 gives a reward of a value of zero in Step S19. When the reward output unit 4021 determines cutoff frequency fcut(S′)<cutoff frequency fcut(S) in Step S17, the reward output unit 4021 gives a reward of a negative value in Step S20.

When any one of Step S18, Step S19 and Step S20 is completed, in Step S21, the reward output unit 4021 adds the reward given in Step S16 and the reward given in any of Step S18, Step S19 and Step S20.

Next, in Step S22, the value function updating unit 4022 updates the value function Q stored in the value function storage unit 404 based on the value of the total reward calculated in Step S21. After that, the flow returns to Step S12 again, and the above-described processing is repeated, whereby the value function Q converges on an appropriate value. It is noted that the processing may end on a condition that the above-described processing is repeated a predetermined number of times or for a predetermined period of time. Although Step S22 illustrates online update, the online update may be replaced with batch update or mini-batch update.

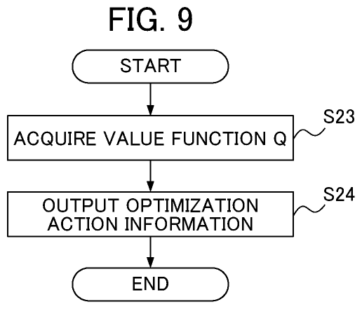

As described above, the present embodiment has an effect that the operation described with reference to FIG. 8 makes it possible to acquire an appropriate value function for adjusting the integral gain K1v and the proportional gain K2v of the velocity control unit 120 and/or the respective coefficients ω_{c}, τ, δ of the transfer function of the filter 130 by using the machine learning unit 400, and simplify the optimization of the integral gain K1v and the proportional gain K2v of the velocity control unit 120 and/or the respective coefficients ω_{c}, τ, δ of the transfer function of the filter 130. Next, an operation for generation of the optimization action information by the optimization action information output unit 405 will be described with reference to the flowchart of FIG. 9. First, in Step S23, the optimization action information output unit 405 acquires the value function Q stored in the value function storage unit 404. The value function Q is updated by the value function updating unit 4022 performing Q-learning as described above.

In Step S24, the optimization action information output unit 405 generates the optimization action information based on this value function Q, and outputs the generated optimization action information to the velocity control unit 120 and/or the filter 130.

Further, in the present embodiment, the operation described with reference to FIG. 9 makes it possible to generate the optimization action information based on the value function Q obtained by learning to be performed by the machine learning unit 400, simplify the adjustment of the currently set integral gain K1v and proportional gain K2v of the velocity control unit 120 and/or the respective currently set coefficients ω_{c}, τ, δ of the transfer function of the filter 130 based on the generated optimization action information, stabilize the servo control unit 100, and increase the response speed.

The operation described above with reference to FIG. 8 and FIG. 9 is an operation for giving a reward based on the cutoff frequency by the above-mentioned method (1) for increasing the response speed after giving a reward depending on whether the Nyquist path passes through the inside of a closed curve in order to enhance the stability of the servo system. However, the present embodiment may use a method (2) for determining a reward based on a closed-loop characteristic or a method (3) for determining a reward so that the shortest distance d is closer to the radius r in order to increase the response speed.

Further, in order to enhance the stability of the servo system, the present embodiment may use a method for giving a reward based on the comparison between the closed loop characteristic and the normative model to suppress the resonance as described in the above-mentioned example considering the resonance after giving a reward depending on whether the Nyquist path passes through the inside of the closed curve.

Each component included in the above-described controller can be implemented by hardware, software, or a combination thereof. Further, the servo control method to be performed by the cooperation of the respective components included in the above controller can also be implemented by hardware, software, or a combination thereof. Here, being realized by software means being realized when a computer reads and executes a program.

The program can be stored and supplied to a computer by using various types of non-transitory computer-readable media. The non-transitory computer-readable media include various types of tangible storage media. Examples of the non-transitory computer-readable media include a magnetic recording medium (for example, hard disk drive), a magnetooptical recording medium (for example, magnetooptical disc), CD-ROM (Read Only Memory), CD-R, CD-R/W, a semiconductor memory (for example, a mask ROM, PROM (Programmable ROM), EPROM (Erasable PROM), a flash ROM, and RAM (random access memory)). The program may also be supplied to a computer by various types of transitory computer-readable media.

The above-described embodiment is a preferred embodiment of the present invention. However, the scope of the present invention is not limited to the present embodiment, and the present invention can be embodied in various modifications without departing from the spirit of the present invention.

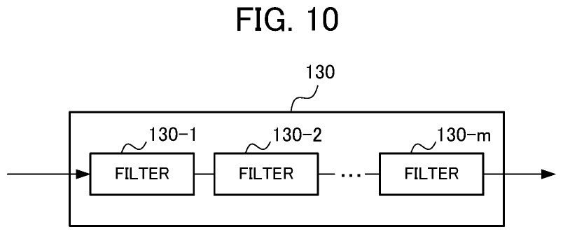

In the above-described embodiment, the case where one filter is provided has been described, but the filter 130 may be configured by connecting a plurality of filters corresponding to different frequency bands in series. FIG. 10 is a block diagram showing an example in which a plurality of filters are directly connected to one another to configure a filter. In FIG. 10, when there are m (m represents a natural number of 2 or more) resonance points, the filter 130 is configured by connecting m filters 130-1 to 130-m in series. Optimal values are obtained by performing machine learning for the respective coefficients ω_{c}, τ, δ of the m filters 130-1 to 130-m.

Further, the configuration of the controller has the following configuration in addition to the configuration shown in FIG. 1.

<Modification Example in which the Machine Learning Unit is Provided Outside the Servo Control Unit>

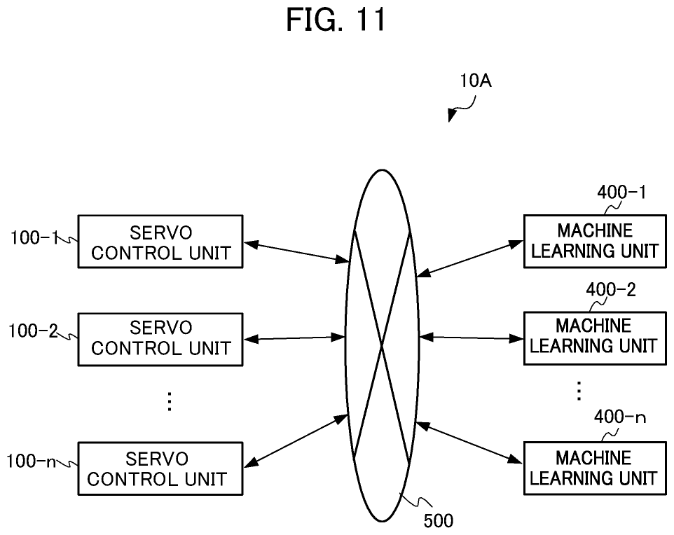

FIG. 11 is a block diagram showing another configuration example of the controller. The difference of a controller 10A shown in FIG. 11 from the controller 10 shown in FIG. 1 resides in that n (n represents a natural number of 2 or more) servo control units 100-1 to 100-n are connected to n machine learning units 400-1 to 400-n via a network 500, and each of the servo control units 100-1 to 100-n includes a frequency generation unit 200 and a frequency response calculation unit 300. The machine learning units 400-1 to 400-n have the same configuration as the machine learning unit 400 shown in FIG. 2. Each of the servo control units 100-1 to 100-n corresponds to the servo controller, and each of the machine learning units 400-1 to 400-n corresponds to the machine learning device. It is needless to say that one or both of the frequency generation unit 200 and the frequency response calculation unit 300 may be provided outside the servo control units 100-1 to 100-n.

Here, the servo control unit 100-1 and the machine learning unit 400-1 are paired in one-to-one correspondence, and are connected to each other so that they can communicate with each other. With respect to the servo control units 100-2 to 100-n and the machine learning units 400-2 to 400-n, they are also connected in the same manner as the servo control unit 100-1 and the machine learning unit 400-1. In FIG. 11, the n pairs of the servo control units 100-1 to 100-n and the machine learning unit 400-1 to 400-n are connected via the network 500, but the servo control unit and the machine learning unit in each of the n pairs of the servo control units 100-1 to 100-n and the machine learning units 400-1 to 400-n may be directly connected to each other via a connection interface. The n pairs of the servo control units 100-1 to 100-n and the machine learning units 400-1 to 400-n, for example, a plurality of pairs may be installed in the same factory, or the n pairs may be installed in different factories.

The network 500 is, for example, a LAN (Local Area Network) constructed in a factory, the Internet, a public telephone network, or a combination thereof. A specific communication style in the network 500, or which one of a wired connection and a wireless connection it is not particularly limited.

### <Degree of Freedom of System Configuration>

In the above-described embodiment, the servo control units 100-1 to 100-n and the machine learning units 400-1 to 400-n are paired in one-to-one correspondence so as to be capable of communicating with each other, but one machine learning unit may be connected to a plurality of servo control units via the network 500 so as to be capable of communicating with the servo control units to perform machine learning of each servo control unit. At that time, the respective functions of one machine learning unit may be appropriately distributed to a plurality of servers as a distributed processing system. Further, the respective functions of one machine learning unit may be implemented by using a virtual server function or the like on the cloud.

Further, there are n machine learning units 400-1 to 400-n corresponding to the servo control units 100-1 to 100-n of the same model name, the same specification, or the same series, the controller 10A may be configured to share learning results in the respective machine learning units 400-1 to 400-n. By doing so, a more optimal model can be constructed.

The machine learning device, the controller, and the machine learning method according to the present disclosure can take various embodiments having the following configurations, including the above-described embodiment.

(1) A machine learning device (for example, the machine learning unit 400) performs machine learning to optimize at least one selected from a coefficient of at least one filter (for example, the filter 130) provided in a servo controller (for example, the servo control unit 100) for controlling a motor (for example, the motor 150) and a feedback gain.

The machine learning device includes:

a state information acquisition unit (for example, the state information acquisition unit 401) that acquires state information including at least one selected from the coefficient of the filter and the feedback gain, and including an output/input gain and an output/input phase delay of the servo controller;

an action information output unit (for example, the action information output unit 403) that outputs action information including adjustment information of at least one selected from the coefficient and the feedback gain included in the state information;

a reward output unit (for example, the reward output unit 4021) that determines a reward depending on whether a Nyquist path calculated from the output/input gain and the output/input phase delay passes through the inside of a closed curve which contains therein (−1, 0) on a complex plane and passes through a predetermined gain margin and phase margin, and outputs the reward; and

a value function updating unit (the value function updating unit 4022) that updates a value function based on the value of the reward output by the reward output unit, the state information, and the action information.

According to this machine learning device, at least one selected from the feedback gain and the coefficient of the filter can be adjusted in consideration of both the phase margin and the gain margin, and the stability of the servo system can be enhanced.

(2) In the machine learning device described in the foregoing (1), the reward is determined based on a distance between the closed curve and the Nyquist path, and output.
(3) In the machine learning device described in the foregoing (1) or (2), the closed curve is a circle.
(4) In the machine learning device described in any one of the foregoing (1) to (3), the reward output unit outputs a total reward obtained by adding a reward calculated based on a cutoff frequency to the foregoing reward. According to this machine learning device, it is possible to increase the feedback gain and increase the response speed.
(5) In the machine learning device described in any one of the foregoing (1) to (3), the reward output unit outputs a total reward obtained by adding a reward calculated based on a closed loop characteristic to the foregoing reward. According to this machine learning device, it is possible to increase the feedback gain and increase the response speed.
(6) In the machine learning device described in any one of the foregoing (1) to (3), the reward output unit outputs a total reward obtained by adding a reward calculated by comparing the output/input gain with a pre-calculated normative gain to the foregoing reward. According to this machine learning device, it is possible to suppress resonance.
(7) In the machine learning device described in any one of the foregoing (1) to (6), the output/input gain and the output/input phase delay are calculated by a frequency response calculation device (for example, the frequency response calculation unit 300), and
the frequency response calculation device uses an input signal of a frequency-changing sinusoidal wave and speed feedback information of the servo controller to calculate the output/input gain and the output/input phase delay.
(8) The machine learning device described in any one of the foregoing (1) to (7) further includes an optimization action information output unit (for example, the optimization action information output unit 405) that outputs adjustment information of at least one selected from the coefficient and the feedback gain based on a value function updated by the value function updating unit.
(9) A controller includes:

the machine learning device (the machine learning unit 400) described in any one of the foregoing (1) to the foregoing (8);

a servo controller (for example, the servo control unit 100) that controls a motor and has at least one filter and a control unit (for example, the velocity control unit 120) configured to set a feedback gain; and

a frequency response calculation device (for example, the frequency response calculation unit 300) that calculates an output/input gain and an output/input phase delay of the servo controller, in the servo controller.

According to this controller, at least one selected from the feedback gain and the coefficient of the filter can be adjusted in consideration of both the phase margin and the gain margin, and the stability of the servo system is enhanced.

(10) A machine learning method is for a machine learning device (for example, the machine learning unit 400) which performs machine learning to optimize at least one selected from a coefficient of at least one filter (for example, the filter 130) provided in a servo controller (for example, the servo control unit 100) for controlling a motor (for example, the motor 150) and a feedback gain.

The method includes:

acquiring state information that includes at least one selected from the coefficient of the filter and the feedback gain, and includes an output/input gain and an output/input phase delay of the servo controller;

outputting action information that includes adjustment information of at least one selected from the coefficient and the feedback gain included in the state information; determining a reward depending on whether a Nyquist path calculated from the output/input gain and the output/input phase delay passes through an inside of a closed curve which contains therein (−1, 0) on a complex plane and passes through a predetermined gain margin and phase margin, and outputting the reward; and

updating a value function, based on a value of the reward, the state information, and the action information.

According to this machine learning method, at least one selected from the feedback gain and the coefficient of the filter can be adjusted in consideration of both the phase margin and the gain margin, and the stability of the servo system can be enhanced.

### EXPLANATION OF REFERENCE NUMERALS

10, 10A: Controller
100, 100-1 to 100-n: Servo control unit
110: Subtractor
120: Velocity control unit
130: Filter
140: Current control unit
150: Motor
200: Frequency generation unit
300: Frequency response calculation unit
400, 400-1 to 400-n: Machine learning unit
401: State information acquisition unit
402: Learning unit
403: Action information output unit
404: Value function storage unit
405: Optimization action information output unit
500: Network

1. A machine learning device which performs machine learning to optimize at least one selected from a coefficient of at least one filter and a feedback gain which are provided in a servo controller for controlling a motor, the machine learning device comprising:
a state information acquisition unit that acquires state information including at least one selected from the coefficient of the filter and the feedback gain, and including an output/input gain and an output/input phase delay of the servo controller;
an action information output unit that outputs action information including adjustment information of at least one selected from the coefficient and the feedback gain included in the state information;
a reward output unit that determines a reward depending on whether a Nyquist path calculated from the output/input gain and the output/input phase delay passes through an inside of a closed curve which contains therein (−1, 0) on a complex plane and passes through a predetermined gain margin and phase margin, and outputs the reward; and
a value function updating unit that updates a value function, based on a value of the reward output by the reward output unit, the state information, and the action information.

2. The machine learning device according to claim 1,
wherein the reward output unit determines the reward based on a distance between the closed curve and the Nyquist path, and outputs the reward.

3. The machine learning device according to claim 1,
wherein the closed curve is a circle.

4. The machine learning device according to claim 1,
wherein the reward output unit outputs a total reward obtained by adding a reward calculated based on a cutoff frequency to the reward.

5. The machine learning device according to claim 1,
wherein the reward output unit outputs a total reward obtained by adding a reward calculated based on a closed loop characteristic to the reward.

6. The machine learning device according to claim 1,
wherein the reward output unit outputs a total reward obtained by adding a reward calculated by comparing the output/input gain with a pre-calculated normative gain to the reward.

7. The machine learning device according to claim 1,
wherein the output/input gain and the output/input phase delay are calculated by a frequency response calculation device, and
the frequency response calculation device calculates the output/input gain and the output/input phase delay by using an input signal of a frequency-changing sinusoidal wave and speed feedback information of the servo controller.

8. The machine learning device according to claim 1, further comprising an optimization action information output unit that outputs adjustment information of at least one selected from the coefficient and the feedback gain based on a value function updated by the value function updating unit.

9. A controller comprising:
the machine learning device according to claim 1;
a servo controller that controls a motor and includes at least one filter and a control unit configured to set a feedback gain; and
a frequency response calculation device that calculates an output/input gain and an output/input phase delay of the servo controller, in the servo controller.

10. A machine learning method for a machine learning device which performs machine learning to optimize at least one selected from a coefficient of at least one filter and a feedback gain which are provided in a servo controller for controlling a motor, the method comprising:
acquiring state information that includes at least one selected from the coefficient of the filter and the feedback gain, and includes an output/input gain and an output/input phase delay of the servo controller;
outputting action information that includes adjustment information of at least one selected from the coefficient and the feedback gain included in the state information;
determining a reward depending on whether a Nyquist path calculated from the output/input gain and the output/input phase delay passes through an inside of a closed curve which contains therein (−1, 0) on a complex plane and passes through a predetermined gain margin and phase margin, and outputting the reward; and
updating a value function, based on a value of the reward, the state information, and the action information.
